(19) United States
(12) Patent Application Publication
(10) Pub. No.: US 2020/0384687 A1
(43) Pub. Date: Dec. 10, 2020

(54) METHOD OF 3D-PRINTING AND COMPOSITE MATERIAL

(71) Applicant: INDUSTRIAL TECHNOLOGY RESEARCH INSTITUTE, Hsinchu (TW)

(72) Inventors: Yi-Tsung PAN, Tainan City (TW); Shinn-Jen CHANG, Hsinchu City (TW); Wesley Jen-Yang CHANG, Tainan City (TW); Jer-Young CHEN, Hsinchu City (TW); Feng-Meei WU, Hsinchu City (TW)

(73) Assignee: INDUSTRIAL TECHNOLOGY RESEARCH INSTITUTE, Hsinchu (TW)

(21) Appl. No.: 16/895,027

(22) Filed: Jun. 8, 2020

Related U.S. Application Data
(60) Provisional application No. 62/859,287, filed on Jun. 10, 2019.

(51) Int. Cl. B29C 64/165; B29C 64/307; C09D 11/033

(52) U.S. Cl. CPC B29C 64/165; B33Y 70/00; C09D 11/033; B29C 64/307

(57) ABSTRACT

A composite material is provided, which includes powder of a polymer uniformly distributed in a blend of the polymer and a compound. The polymer and the compound have similar molecular structure. The compound has a first initially melting temperature and a first completely melting temperature. The polymer has a second initially melting temperature and a second completely melting temperature. The first completely melting temperature is lower than the second initially melting temperature.

### CROSS REFERENCE TO RELATED APPLICATIONS

This application claims the benefit of U.S. Provisional Application No. 62/859,287, filed on Jun. 10, 2019, the entirety of which is incorporated by reference herein.

### TECHNICAL FIELD

The technical field relates to 3D printing method.

### BACKGROUND

Two of the most well-known methods for rapid prototyping are the selective laser sintering process and the liquid binder three-dimensional printing process. The laser-sintering and liquid binder techniques are advantageous, because they create parts directly from computer-generated design data and can produce parts having complex geometries. Moreover, three-dimensional printing can be quicker and less expensive than machining of prototype parts or production of cast or molded parts using conventional “hard” or “soft” tooling techniques, which can take from a few weeks to several months, depending on the complexity of the item.

While liquid binder techniques has an advantage in high speed and lower cost for dispensing the liquids compared to the laser sintering process, there exists a need in the art of the liquid-based 3D printing process to improve production efficiency. For example, 3D object of TPEE cannot be manufactured by binder process, it can only be manufactured by selective laser sinter (SLS) at present.

### SUMMARY

One embodiment of the disclosure provides a method of 3D-printing, including: (1) forming a first powder layer of a polymer; (2) applying an ink to the first powder layer to form a first pattern in the first powder layer, wherein the ink includes a compound; (3) pre-heating the first powder layer; (4) forming a second powder layer of the polymer on top of the pre-heated first powder layer; (5) applying the ink to the second powder layer to form a second pattern in the second powder layer; (6) pre-heating the second powder layer; (7) removing parts of the first powder layer and the second powder layer not in contact with the ink; and (8) baking the remained parts of the first powder layer and the second powder layer interacted with the compound to obtain an object. The polymer and the compound have similar molecular structure.

One embodiment of the disclosure provides a composite material, including: powder of a polymer uniformly distributed in a blend of the polymer and a compound, and the polymer and the compound have similar molecular structure. The compound has a first initially melting temperature and a first completely melting temperature, the polymer has a second initially melting temperature and a second completely melting temperature, and the first completely melting temperature is lower than the second initially melting temperature.

One embodiment of the disclosure provides an ink for 3D printing an object of a polymer, including: a compound, wherein the polymer and the compound have similar molecular structure.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGS. 1 to 8 show a method of 3D-printing in one embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

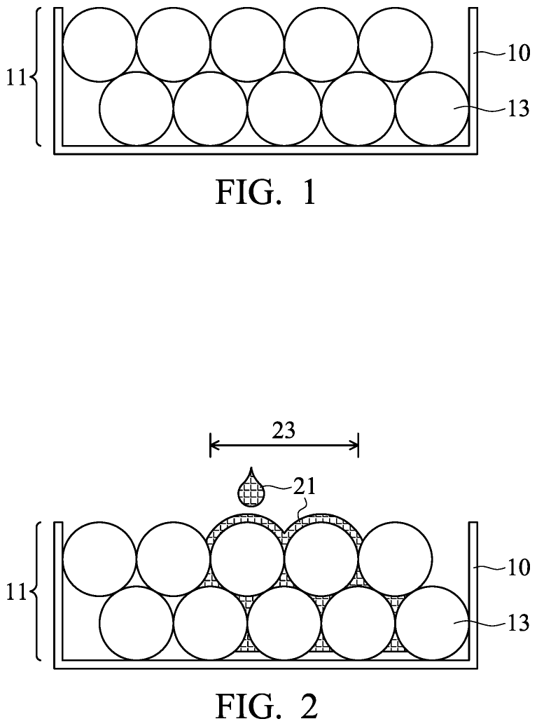

In one embodiment, a method of 3D-printing is provided. As shown in FIG. 1, a powder layer 11 of polymer is formed in a powder bed 10 (e.g. a tank). For example, the polymer powder 13 is spread to form the powder layer 11 with a thickness of 0.001 to 1 mm. In some embodiments, the polymer powder 13 has a diameter of 5 μm to 100 μm.

As shown in FIG. 2, an ink 21 containing compound 31 is applied to the powder layer 11 to form a pattern 23. The compound 31 and the polymer of the polymer powder 13 have similar molecular structure, and the compound 31 can be monomer, oligomer, pre-polymer, or polymer. In some embodiments, the polymer is TPEE, and the compound is polyester. In some embodiments, the polymer is TPU, and the compound is polyurethane.

In some embodiments, the compound contains a hydrophilic group to be dissolved in water to form an aqueous ink 21, and the hydrophilic group includes hydroxyl, carboxylic acid, amino, ammonium, phosphate, sulphate, sulfonic, sulfhydryl, or polyethylene oxide. In some embodiments, the ink 21 also includes pigment, dye, surfactant, rheology modifier, defoamer, leveling agent, or a combination thereof. In some embodiments, the ink further comprises wetting agent, solvent, or co-solvent, and the compound is dissolved or dispersed in the solvent to form the ink 21. For example, the solvent includes toluene, xylene, ethyl acetate, butyl acetate, methoxy propyl acetate, 2-ethoxyethanol, tetraethylene glycol dimethyl ether, propylene glycol methyl ether acetate, diethylene glycol diethyl ether, water, or a combination thereof.

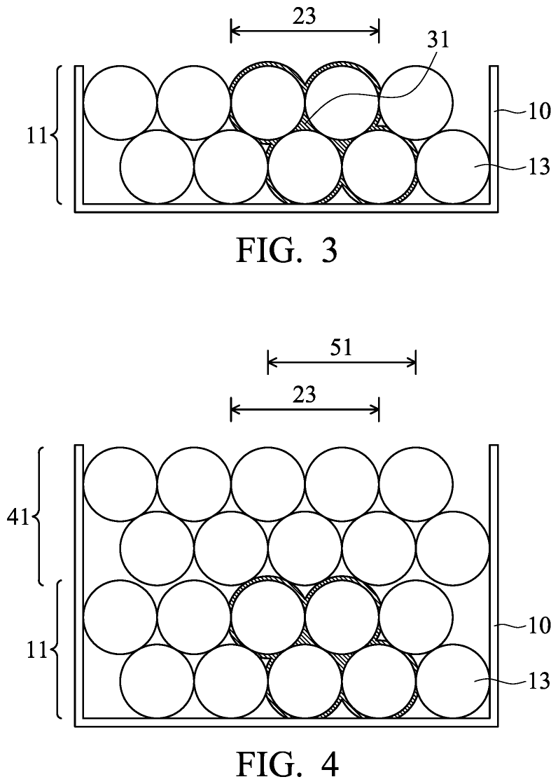

The ink 21 is in contact with the polymer powder 13 in the pattern 23, and not in contact with the polymer powder 13 outside the pattern 23. The method of applying the ink 21 to the powder layer 11 can be inkjet, screen printing, roll printing, another suitable method, or a combination thereof. As shown in FIG. 3, the powder layer 11 is pre-heated. During the pre-heating step, the solvent in the ink 21 is removed, and the compound 31 in the ink 21 is melted to interact with the polymer powder 13. It should be noted that the pre-heating temperature must be higher than the completely melting temperature of the compound 31 in the ink 21 to achieve the above effect. In some embodiments, the pre-heating step can be constant heating or a localized heating. Localized heating can be performed for a period of 0.01 to 300 seconds. If the pre-heating period is too short, the solvent may not be completely removed. If the pre-heating period is too long, it may just increase the process time without any other benefits.

As shown in FIG. 4, a powder layer 41 of the polymer is subsequently formed on top of the pre-heated powder layer 11. For example, the polymer powder 13 is spread to form the powder layer 41. The thickness of the powder layer 41 and the diameter of the polymer powder 13 in the powder layer 41 can be similar to the thickness of the powder layer 11 and the diameter of the polymer powder 13 in the powder layer 11 as described above. However, the thickness of the powder layer 41 and the diameter of the polymer powder 13 in the powder layer 41 can be the different from the thickness of the powder layer 11 and the diameter of the polymer powder 13 in the powder layer 11 if necessary.

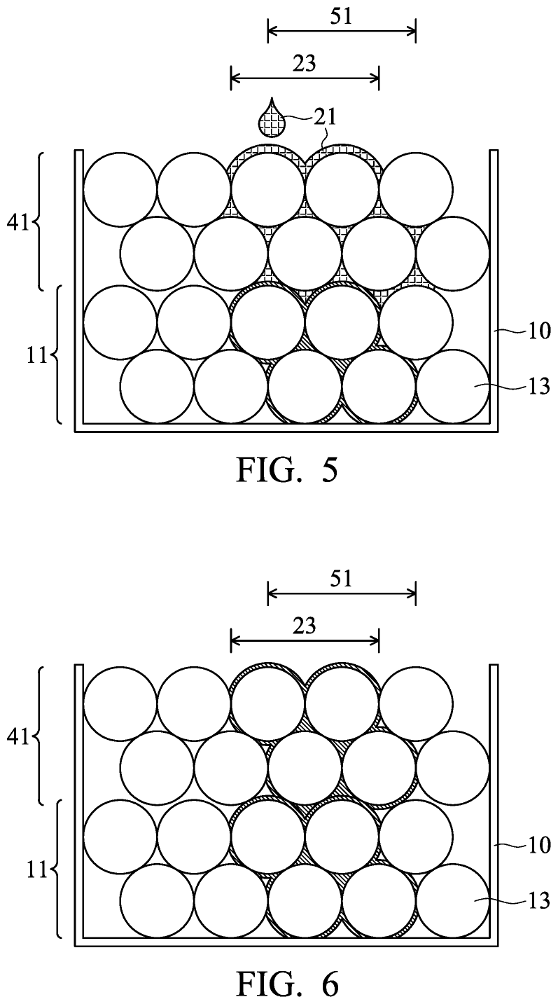

As shown in FIG. 5, the ink 21 is applied to the powder layer 41 to form a pattern 51 in the powder layer 41. The ink 21 is in contact with the polymer powder 13 in the pattern 51, and not in contact with the polymer powder 13 outside the pattern 51. In FIG. 5, some ink 21 flows to the space between the powder layer 11 and the powder layer 41. However, if the pattern 51 is larger than the pattern 23, the ink 21 will not flow to the space (between the powder layer 11 and powder layer 41) outside the pattern 23 to prevent the product from deforming.

As shown in FIG. 6, the powder layer 41 is pre-heated. During the pre-heating step, the solvent in the ink 21 is removed, and the compound 31 in the ink 21 is melted to interact with the polymer powder 13 in the powder layer 41. It should be noted that the pre-heating temperature must be higher than the completely melting temperature of the compound 31 to achieve the above effect. The pre-heating period is similar to that described above, and the detailed description is omitted here.

In the above description, the steps of FIGS. 4 to 6 can be repeated several times if necessary. In other words, the steps of forming the powder layer of the polymer powder 13, applying the ink 21 of the compound 31 to the powder layer to form a pattern, and pre-heating the powder layer can be repeated as desired.

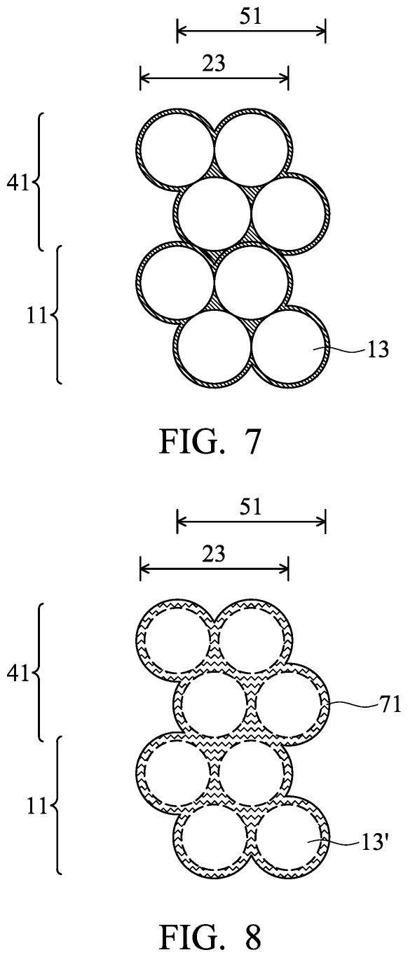

As shown in FIG. 7, the polymer powder 13 in the powder layers 11 and 41 not in contact with the ink 21 (e.g. outside of pattern 23 and pattern 51) are removed. The removed polymer powder can be recycled to form a powder layer for next product.

As shown in FIG. 8, the pre-heated powder layers 11 and 41 are baked. During the baking step, the melted compound 31 and surface of the polymer powder 13 are fused to form a blend 71, and the shrunk-polymer powder 13′ (the surface part of the polymer powder 13 is fused and blended with the compound 31) is uniformly distributed in the blend 71. It should be noted that the baking temperature is lower than the completely melting temperature of the polymer powder 13 and higher than the initially melting temperature of the polymer powder 13. In summary, the compound 31 has a first initially melting temperature and a first completely melting temperature, the polymer powder 13 has a second initially melting temperature and a second completely melting temperature, the first initially melting temperature is lower than the first completely melting temperature, the first completely melting temperature is lower than the second initially melting temperature, and the second initially melting temperature is lower than the second completely melting temperature. The pre-heating temperature is higher than the first completely temperature and lower than the second initially melting temperature, and the baking temperature is higher than the second initially melting temperature and lower than the second completely melting temperature. As such, the polymer powder 13 will be fused with the melted compound 31 by the mechanism of surface diffusion. The polymer powder 13 and the compound 31 from the ink 21 have similar molecular structure, such that the blend 71 and the shrunk polymer powder 13′ are strongly fused without a heterogeneous interface therebetween. In some embodiments, the baking step is performed for a period for 5 minutes to 8 hours, which depends on the product size. If the pre-heating or baking is performed by microwave, the ink 21 may further include microwave receptor. On the other hand, the pre-heating or baking can be performed by oven.

In some embodiments, the polymer of the polymer powder 13 is polyester-type polymer, and the compound 31 of the ink 21 is ester-type monomer, oligomer, pre-polymer, or polymer. The polymer has a weight average molecular weight of 10000 to 100000, and the compound has a weight average molecular weight of 200 to 100000. For example, the polymer can be thermoplastic polyester elastomer, polylactic acid, polyethylene terephthalate, polybutylene terephthalate, polyesteramide, copolyester, or another suitable polyester-type polymer. The compound can be polyglycolic acid, polylactic acid, polycaprolactone, polyhydroxyalkanoate, polyhydroxybutyrate, polyethylene adipate, polybutylene succinate, polyethylene terephthalate, polybutylene terephthalate, polytrimethylene terephthalate, polyethylene naphthalate, another suitable polyester-type polymer, monomer thereof, oligomer thereof, or pre-polymer thereof.

In some embodiments, the polymer of the polymer powder 13 is polyurethane-type polymer, and the compound 31 of the ink 21 is urethane-type monomer, oligomer, pre-polymer, or polymer. The polymer has a weight average molecular weight of 10000 to 200000, and the compound has a weight average molecular weight of 200 to 200000.

In some embodiments, the polymer of the polymer powder 31 is polyamide-type polymer, and the compound 31 of the ink 21 is amide-type monomer, oligomer, pre-polymer, or polymer. The polymer has a weight average molecular weight of 10000 to 100000, and the compound has a weight average molecular weight of 200 to 100000. The weight average molecular weight of the polymer is related to the initial melting point and the completely melting point of the polymer of the polymer powder 31. For example, the polymer can be TPAE, nylon 12, nylon 6, or another suitable polyamide-type polymer. The compound can be nylon 6, nylon 66, nylon 6T, copolyamide, another suitable polyamide polymer, monomer thereof, oligomer thereof, or pre-polymer thereof.

In some embodiments, the polymer of the polymer powder 13 is polyacrylate-type polymer, and the compound 31 of the ink 21 is acrylate-type monomer, oligomer, pre-polymer, or polymer. The polymer has a weight average molecular weight of 10000 to 1200000, and the compound has a weight average molecular weight of 50 to 1200000. For example, the polymer can be polymethyl methacrylate, polyacrylate, polyacrylic acid, or another suitable polyacrylate-type polymer, and the compound includes polyacrylate, polyacrylic acid, another suitable polyacrylate-type polymer, monomer thereof, oligomer thereof, or pre-polymer thereof.

In some embodiments, the polymer of the polymer powder 13 is polyolefin-type polymer, and the compound 31 of the ink 21 is olefin-type monomer, oligomer, pre-polymer, or polymer. The polymer has a weight average molecular weight of 10000 to 1500000, and the compound has a weight average molecular weight of 200 to 1500000. For example, the polymer can be polyvinyl alcohol, polyolefin, or another suitable polyolefin-type polymer, and the compound can be polyethylene, polypropylene, polystyrene, polyvinyl chloride, another suitable polyolefin-type polymer, monomer thereof, oligomer thereof, or pre-polymer thereof.

In some embodiments, the compound 31 is dissolved or dispersed in the solvent to form the ink 21. The solvent can be water, toluene, xylene, ethyl acetate, butyl acetate, methoxy propyl acetate, 2-ethoxyethanol, tetraethylene glycol dimethyl ether, propylene glycol methyl ether acetate, diethylene glycol diethyl ether, ethylene glycol monobutyl ether, Carbitol solvent, butyl Carbitol, DPnB glycol ether, dipropylene glycol n-butyl ether, another suitable solvent, or a combination thereof. In some embodiments, the compound 31 contains a hydrophilic group to be dissolved in water to form an aqueous ink 21. For example, the hydrophilic groups include hydroxyl, carboxylic acid, amino, ammonium, phosphate, sulphate, sulfonic, sulfhydryl, or polyethylene oxide.

In addition, the ink 21 of the compound 31 can further include dye, pigment, colorants, surfactant, rheology modifier, defoamer, leveling agent, or another suitable additive to help the 3D-printing or change the properties or appearance (such as the color) of the final product (e.g. object).

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1

Thermoplastic polyester elastomer powder (TPEE, Hytrel 4056 commercially available from Dupont) was spread to form a powder layer with a thickness of 0.16 mm. 15 parts by weight of polyester (which was synthesized from 23 parts by weight of dimethylsulfoisophthalate, 24 parts by weight of ethylene glycol, and 52 parts by weight of terephthalic acid under 250° C. for 8 hours), 6 parts by weight of diethylene glycol (DEG), 8 parts by weight of triethylene glycol (TEG), 10 parts weight of 5-chloromethylfurfural (CMF), 2 parts by weight of wetting agent BYK-333 (commercially available from BYK), 0.05 parts by weight of wetting agent BYK-348 (commercially available from BYK), 0.275 parts by weight of wetting agent BYK-3455 (commercially available from BYK), 1.05 parts by weight of wetting agent Surfynol 465 (commercially available from Evonik), and 57.625 parts by weight of water were mixed to form an aqueous ink. The aqueous ink was inkjetted to the powder layer to form a pattern. The aqueous ink was in contact with the TPEE powder in the pattern, and not in contact with the TPEE powder outside of the pattern. The powder layer was pre-heated to 90° C. and kept at 90° C. for 2 seconds. During the pre-heating step, the solvent of the aqueous ink was removed, and the polyester in the aqueous ink was melted to interact with the TPEE powder. Thereafter, the steps of spreading the TPEE powder to form a powder layer, inkjetting the aqueous ink to the TPEE powder layer, and pre-heating the powder layer were repeated 50 times. Parts of the TPEE powder layers not in contact with the aqueous ink were removed. Thereafter, the pre-heated powder layers were heated to 165° C. for baking step and kept at 165° C. for 20 minutes to obtain a product. The product was a block of 246 mm×29 mm×2 mm. During the baking step, the melted polyester and surface of the TPEE powder were fused to form a blend, and the shrunk TPEE powder (the surface part of the TPEE powder was fused and blended with the melted polyester) was uniformly distributed in the blend. Because the baking temperature was lower than the completely melting point of the TPEE powder and higher than the initially melting point of the TPEE powder, the TPEE powder would not be completely melted and the fused portion blended with the melted polyester. However, the TPEE powder and the polyester in the aqueous ink were the same type of polymer (e.g. the polyester type), the blend and the shrunk TPEE powder were strongly fused without a heterogeneous interface therebetween. The product had a tensile strength of 180 kgf/cm² (tested by the standard ASTM D412).

### Example 2

Polybutylene terephthalate powder (PBT, Toraymill™ PBT commercially available from Toray) was spread to form a powder layer with a thickness of 0.16 mm. 15 parts by weight of copolyester (which was synthesized from 23 parts by weight of dimethylsulfoisophthalate, 24 parts by weight of ethylene glycol, and 52 parts by weight of terephthalic acid under 250° C. for 8 hours), 72.9 parts by weight of parts by weight of 2-ethoxyethanol, 17 parts by weight of ethyl acetate, and 0.1 parts by weight of wetting agent BYK-333 were mixed to form a solvent-based ink. The solvent-based ink was inkjetted to the powder layer to form a pattern. The solvent-based ink was in contact with the PBT powder in the pattern, and not in contact with the PBT powder outside of the pattern. The powder layer was pre-heated to 90° C. and kept at 90° C. for 2 seconds. During the pre-heating step, the solvent of the solvent-based ink was removed, and the copolyester in the solvent-based ink was melted to interact with the PBT powder. Thereafter, the steps of spreading the PBT powder to form a powder layer, inkjetting the solvent-based ink to the PBT powder layer, and pre-heating the powder layer were repeated 50 times. Parts of the PBT powder layers not in contact with the solvent-based ink were removed. Thereafter, the pre-heated powder layers were heated to 160° C. for baking step and kept at 160° C. for 20 minutes to obtain a product. The product was a block of 246 mm×29 mm×2 mm. During the baking step, the melted copolyester and surface of the PBT powder were fused to form a blend, and the shrunk PBT powder (the surface part of the PBT powder was fused and blended with the melted copolyester) was uniformly distributed in the blend. Because the baking temperature was lower than the completely melting point of the PBT powder and higher than the initially melting point of the PBT powder, the PBT powder would not be completely melted and the fused potion blended with the melted copolyester. However, the PBT powder and the copolyester in the solvent-based ink were the same type of polymer (e.g. the polyester type), the blend and the shrunk PBT powder were strongly fused without a heterogeneous interface therebetween. The product had a tensile strength of 300 kgf/cm² (tested by the standard ASTM D412).

### Example 3

Thermoplastic polyurethane powder (TPU, Ultrasint 3D TPU01 commercially available from BASF) was spread to form a powder layer with a thickness of 0.16 mm. 15 parts by weight of polyurethane (which was synthesized from 47 parts by weight of hexamethylene diisocyanate, 5 parts by weight of 1,4-butanediol, 14 parts by weight of 5-sulfoisophthalic acid sodium salt and 34 parts by weight of polyethylene glycol with molecular weight 200 under 80° C. for 1 hour), 6 parts by weight of ethanol, 2 parts by weight of wetting agent BYK-333, 0.05 parts by weight of wetting agent BYK-348, 0.275 parts by weight of wetting agent BYK-3455, 1.05 parts by weight of wetting agent Surfynol 465, and 57.625 parts by weight of water were mixed to form an aqueous ink. The aqueous ink was inkjetted to the powder layer to form a pattern. The aqueous ink was in contact with the TPU powder in the pattern, and not in contact with the TPU powder outside of the pattern. The powder layer was pre-heated to 90° C. and kept at 90° C. for 2 seconds. During the pre-heating step, the solvent of the aqueous ink was removed, and the polyurethane in the aqueous ink was melted to interact with the TPU powder. Thereafter, the steps of spreading the TPU powder to form a powder layer, inkjetting the aqueous ink to the TPU powder layer, and pre-heating the powder layer were repeated 50 times. Parts of the TPU powder layers not in contact with the aqueous ink were removed. Thereafter, the pre-heated powder layers were heated to 160° C. for baking step and kept at 160° C. for 20 minutes to obtain a product. The product was a block of 246 mm×29 mm×2 mm. During the baking step, the melted polyurethane and surface of the TPU powder were fused to form a blend, and the shrunk TPU powder (the surface part of the TPU powder was fused and blended with the melted polyurethane) was uniformly distributed in the blend. Because the baking temperature was lower than the completely melting point of the TPU powder and higher than the initially melting point of the TPU powder, the TPU powder would not be completely melted and the fused portion blended with the melted polyurethaner. However, the TPU powder and the polyurethane in the aqueous ink were the same type of polymer (e.g. the polyurethane type), the blend and the shrunk TPU powder were strongly fused without a heterogeneous interface therebetween. The product had a tensile strength of 65 kgf/cm² (tested by the standard ASTM D412).

### Example 4

TPU powder (Ultrasint 3D TPU01 commercially available from BASF) was spread to form a powder layer with a thickness of 0.16 mm. 15 parts by weight of TPU (which was synthesized from 32 parts by weight of methylene diphenyl diisocyanate, 51 parts by weight of DIEXTER® G200, 13 parts by weight of 5-Sulfoisophthalic acid sodium salt, and 5 parts by weight of 1,4-butanediol under 80° C. for 1 hour), 72.9 parts by weight of parts by weight of 2-ethoxyethanol, 0.1 parts by weight of ethyl acetate, and 17 parts by weight of wetting agent B410 (commercially available from BYK) were mixed to form a solvent-based ink. The solvent-based ink was inkjetted to the powder layer to form a pattern. The solvent-based ink was in contact with the TPU powder in the pattern, and not in contact with the TPU powder outside of the pattern. The powder layer was pre-heated to 90° C. and kept at 90° C. for 2 seconds. During the pre-heating step, the solvent of the solvent-based ink was removed, and the TPU in the solvent-based ink was melted to interact with the TPU powder. Thereafter, the steps of spreading the TPU powder to form a powder layer, inkjetting the solvent-based ink to the TPU powder layer, and pre-heating the powder layer were repeated 50 times. Parts of the TPU powder layers not in contact with the solvent-based ink were removed. Thereafter, the pre-heated powder layers were heated to 160° C. for baking step and kept at 160° C. for 20 minutes to obtain a product. The product was a block of 246 mm×29 mm×2 mm. During the baking step, the melted TPU and surface of the TPU powder were fused to form a blend, and the shrunk TPU powder (the surface part of the TPU powder was fused and blended with the melted TPU) was uniformly distributed in the blend. Because the baking temperature was lower than the completely melting point of the TPU powder and higher than the initially melting point of the TPU powder, the TPU powder would not be completely melted and the fused portion blended with the melted TPU. However, the TPU powder and the TPU in the solvent-based ink were the same type of polymer (e.g. the polyurethane type), the blend and the shrunk TPU powder were strongly fused without a heterogeneous interface therebetween. The product had a tensile strength of 66 kgf/cm² (tested by the standard ASTM D412).

### Example 5

TPAE powder (thermoplastic polyamide elastomer, Pebax 4533 commercially available from ARKEMA) was spread to form a powder layer with a thickness of 0.16 mm. 15 parts by weight of polyamide (which was synthesized from 21 parts by weight of dimethyl 5-sulfoisophthalate sodium salt, 40 parts by weight of caprolactam, 39 parts by weight of Jeffamine ED-900 under 240° C. for 8 hours), 0.05 parts by weight of wetting agent BYK-333, 0.5 parts by weight of wetting agent B410, and 20 parts by weight of propylene glycol methyl ether acetate (PMA) were mixed to form a solvent-based ink. The solvent-based ink was inkjetted to the powder layer to form a pattern. The solvent-based ink was in contact with the TPAE powder in the pattern, and not in contact with the TPAE powder outside of the pattern. The powder layer was pre-heated to 90° C. and kept at 90° C. for 2 seconds. During the pre-heating step, the solvent of the solvent-based ink was removed, and the polyamide in the solvent-based ink was melted to interact with the TPAE powder. Thereafter, the steps of spreading the TPAE powder to form a powder layer, inkjetting the solvent-based ink to the TPAE powder layer, and pre-heating the powder layer were repeated 50 times. Parts of the TPAE powder layers not in contact with the solvent-based ink were removed. Thereafter, the pre-heated powder layers were heated to 160° C. for baking step and kept at 160° C. for 20 minutes to obtain a product. The product was a block of 246 mm×29 mm×2 mm. During the baking step, the melted polyamide and surface of the TPAE powder were fused to form a blend, and the shrunk TPAE powder (the surface part of the TPAE powder was fused and blended with the melted polyamide) was uniformly distributed in the blend. Because the baking temperature was lower than the completely melting point of the TPAE powder and higher than the initially melting point of the TPAE powder, the TPAE powder would not be completely melted and the fused portion blended with the melted polyamide. However, the TPAE powder and the polyamide in the solvent-based ink were the same type of polymer (e.g. the polyamide type), the blend and the shrunk TPAE powder were strongly fused without a heterogeneous interface therebetween. The product had a tensile strength of 270 kgf/cm² (tested by the standard ASTM D412).

### Example 6

Nylon 12 powder (VESTOSINT 3D Z2773 PA 12 commercially available from Evonik) was spread to form a powder layer with a thickness of 0.16 mm. 15 parts by weight of polyamide (which was synthesized from 21 parts by weight of dimethyl 5-sulfoisophthalate sodium salt, 40 parts by weight of caprolactam, 39 parts by weight of Jeffamine ED-900 under 240° C. for 8 hours), 0.05 parts by weight of wetting agent BYK-333, 0.5 parts by weight of wetting agent B410, and 20 parts by weight of PMA were mixed to form a solvent-based ink. The solvent-based ink was inkjetted to the powder layer to form a pattern. The solvent-based ink was in contact with the nylon 12 powder in the pattern, and not in contact with the nylon 12 powder outside of the pattern. The powder layer was pre-heated to 90° C. and kept at 90° C. for 2 seconds. During the pre-heating step, the solvent of the solvent-based ink was removed, and the polyamide in the solvent-based ink was melted to adhere the nylon 12 powder. Thereafter, the steps of spreading the Nylon 12 powder to form a powder layer, inkjetting the solvent-based ink to the nylon 12 powder layer, and pre-heating the powder layer were repeated 50 times. Parts of the nylon 12 powder layers not in contact with the solvent-based ink were removed. Thereafter, the pre-heated powder layers were heated to 160° C. for baking step and kept at 160° C. for 20 minutes to obtain a product. The product was a block of 246 mm×29 mm×2 mm. During the baking step, the melted polyamide and surface of the nylon 12 powder were fused to form a blend, and the shrunk nylon 12 powder (the surface part of the nylon 12 powder was fused and blended with the melted polyamide) was uniformly distributed in the blend. Because the baking temperature was lower than the completely melting point of the nylon 12 powder and higher than the initially melting point of the nylon 12 powder, the nylon 12 powder would not be completely melted and the fused portion blended with the melted polyamide. However, the nylon 12 powder and the polyamide in the solvent-based ink were the same type of polymer (e.g. the polyamide type), the blend and the shrunk nylon 12 powder were strongly fused without a heterogeneous interface therebetween. The product had a tensile strength of 310 kgf/cm² (tested by the standard ASTM D412).

### Example 7

Polyolefin powder (Ultrasint PP nat 01 commercially available from BASF) was spread to form a powder layer with a thickness of 0.16 mm. 10 parts by weight of atactic polypropylene oxide (APAO, Vistamaxx 6502 commercially available from ExxonMobil Chemical), 0.1 parts by weight of wetting agent BYK-333, 0.5 parts by weight of wetting agent B410, and 69.4 parts by weight of toluene were mixed to form a solvent-based ink. The solvent-based ink was inkjetted to the powder layer to form a pattern. The solvent-based ink was in contact with the polyolefin powder in the pattern, and not in contact with the polyolefin powder outside of the pattern. The powder layer was pre-heated to 90° C. and kept at 90° C. for 2 seconds. During the pre-heating step, the solvent of the solvent-based ink was removed, and the APAO in the solvent-based ink was melted to adhere the polyolefin powder. Thereafter, the steps of spreading the polyolefin powder to form a powder layer, inkjetting the solvent-based ink to the polyolefin powder layer, and pre-heating the powder layer were repeated 50 times. Parts of the polyolefin powder layers not in contact with the solvent-based ink were removed. Thereafter, the pre-heated powder layers were heated to 160° C. for baking step and kept at 160° C. for 20 minutes to obtain a product. The product was a block of 246 mm×29 mm×2 mm. During the baking step, the melted APAO and surface of the polyolefin powder were fused to form a blend, and the shrunk polyolefin powder (the surface part of the polyolefin powder was fused and blended with the melted APAO) was uniformly distributed in the blend. Because the baking temperature was lower than the completely melting point of the polyolefin powder and higher than the initially melting point of the polyolefin powder, the polyolefin powder would not be completely melted and the fused portion blended with the melted APAO. However, the polyolefin powder and the APAO in the solvent-based ink were the same type of polymer (e.g. the polyolefin type), the blend and the shrunk polyolefin powder were strongly fused without a heterogeneous interface therebetween. The product had a tensile strength of 180 kgf/cm² (tested by the standard ASTM D412).

### Example 8

Polymethyl methacrylate powder (PMMA, Solupor commercially available from Voxeljet) was spread to form a powder layer with a thickness of 0.16 mm. 100 parts by weight of polyacrylic emulsion (which was synthesized from 42 parts by weight of methyl methacrylate, 50 parts by weight of n-butyl acrylate, 8 parts by weight of acrylic acid, 0.4 parts by weight of sodium peroxodisulfate, and 100 parts by weight of water), 0.1 parts by weight of wetting agent BYK-333, 0.5 parts by weight of wetting agent B410, and 10 parts by weight of water were mixed to form an aqueous ink. The aqueous ink was inkjetted to the powder layer to form a pattern. The aqueous ink was in contact with the PMMA powder in the pattern, and not in contact with the PMAA powder outside of the pattern. The powder layer was pre-heated to 90° C. and kept at 90° C. for 2 seconds. During the pre-heating step, the solvent of the aqueous ink was removed, and the PA in the aqueous ink was melted to adhere the PMMA powder. Thereafter, the steps of spreading the PMMA powder to form a powder layer, inkjetting the aqueous ink to the PMMA powder layer, and pre-heating the powder layer were repeated 50 times. Parts of the PMMA powder layers not in contact with the aqueous ink were removed. Thereafter, the pre-heated powder layers were heated to 160° C. for baking step and kept at 160° C. for 20 minutes to obtain a product. The product was a block of 246 mm×29 mm×2 mm. During the baking step, the melted PA and surface of the PMAA powder were fused to form a blend, and the shrunk polyolefin powder (the surface part of the PMAA powder was fused and blended with the melted PA) was uniformly distributed in the blend.

Because the baking temperature was lower than the completely melting point of the PMAA powder and higher than the initially melting point of the PMAA powder, the PMAA powder would not be completely melted and the fused portion blended with the melted PA. However, the PMAA powder and the PA in the aqueous ink were the same type of polymer (e.g. the polyacrylate type), the blend and the shrunk PMAA powder were strongly fused without a heterogeneous interface therebetween. The product had a tensile strength of 20 kgf/cm² (tested by the standard ASTM D412).

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A method of 3D-printing, comprising:
(1) forming a first powder layer of a polymer;
(2) applying an ink to the first powder layer to form a first pattern in the first powder layer, wherein the ink includes a compound;
(3) pre-heating the first powder layer;
(4) forming a second powder layer of the polymer on top of the pre-heated first powder layer;
(5) applying the ink to the second powder layer to form a second pattern in the second powder layer;
(6) pre-heating the second powder layer;
(7) removing parts of the first powder layer and the second powder layer not in contact with the ink; and
(8) baking the remained parts of the first powder layer and the second powder layer interacted with the compound to obtain an object,
wherein the polymer and the compound have similar structure.

2. The method as claimed in claim 1, wherein
the compound has a first initially melting temperature and a first completely melting temperature,
the polymer has a second initially melting temperature and a second completely melting temperature,
the first initially melting temperature is lower than the first completely melting temperature, the first completely melting temperature is lower than the second initially melting temperature, and the second initially melting temperature is lower than the second completely melting temperature, and
the pre-heating temperature is higher than the first completely temperature and lower than the second initially melting temperature, and the baking temperature is higher than the second initially melting temperature and lower than the second completely melting temperature.

3. The method as claimed in claim 1, wherein the step of (1) to (6) are repeated several cycles.

4. The method as claimed in claim 1, wherein the compound contains a hydrophilic group to be dissolved in water to form an aqueous ink, and the hydrophilic group includes hydroxyl, carboxylic acid, amino, ammonium, phosphate, sulphate, sulfonic, sulfhydryl, or polyethylene oxide.

5. The method as claimed in claim 1, wherein the ink further contains wetting agent, solvent, or co-solvent.

6. The method as claimed in claim 1, wherein the ink further includes pigment, dye, surfactant, rheology modifier, defoamer, leveling agent, or a combination thereof.

7. The method as claimed in claim 5, wherein the compound is dissolved or dispersed in the solvent to form the ink, and the solvent includes toluene, xylene, ethyl acetate, butyl acetate, methoxy propyl acetate, 2-ethoxyethanol, tetraethylene glycol dimethyl ether, propylene glycol methyl ether acetate, diethylene glycol diethyl ether, water, or a combination thereof.

8. The method as claimed in claim 1, wherein the compound comprises monomer, oligomer, pre-polymer, or polymer.

9. The method as claimed in claim 1, wherein the polymer is TPEE, and the compound is polyester.

10. The method as claimed in claim 1, wherein the polymer is TPU, and the compound is polyurethane.

11. The method as claimed in claim 1, wherein the polymer is polyester-type polymer, the compound is ester-type monomer, oligomer, pre-polymer, or polymer, the polymer has a weight average molecular weight of 10000 to 100000, and the compound has a weight average molecular weight of 1000 to 100000.

12. The method as claimed in claim 11, wherein the polymer comprises thermoplastic polyester elastomer, polylactic acid, polyethylene terephthalate, polybutylene terephthalate, polyesteramide, or copolyester, and the compound comprises polyglycolic acid, polylactic acid, polycaprolactone, polyhydroxyalkanoate, polyhydroxybutyrate, polyethylene adipate, polybutylene succinate, polyethylene terephthalate, polybutylene terephthalate, polytrimethylene terephthalate, polyethylene naphthalate, monomer thereof, oligomer thereof, or pre-polymer thereof.

13. The method as claimed in claim 1, wherein the polymer is polyurethane-type polymer, the compound is urethane-type monomer, oligomer, pre-polymer or polymer, the polymer has a weight average molecular weight of 10000 to 100000, and the compound has a weight average molecular weight of 1000 to 40000.

14. The method as claimed in claim 13, wherein the polymer is polyamide-type polymer, the compound is amide-type monomer, oligomer, pre-polymer or polymer, the polymer has a weight average molecular weight of 10000 to 100000, and the compound has a weight average molecular weight of 1000 to 30000.

15. The method as claimed in claim 1, wherein the polymer comprises nylon12, nylon6, or TPAE, and the compound comprises nylon 6, nylon 66, nylon 6T, copolyamide, monomer thereof, oligomer thereof, or pre-polymer thereof.

16. The method as claimed in claim 1, wherein the polymer is polyacrylate-type polymer, the compound is acrylate-type monomer, oligomer, pre-polymer, or polymers, the polymer has a weight average molecular weight of 10000 to 100000, and the compound has a weight average molecular weight of 1000 to 80000.

17. The method as claimed in claim 16, wherein the polymer comprises poly(methyl methacrylate), polyacrylate, or polyacrylic acid, and the compound comprises polyacrylate, polyacrylic acid, monomer thereof, oligomer thereof, or pre-polymer thereof.

18. The method as claimed in claim 1, wherein the polymer is polyolefin-type polymer, the compound is olefin-type monomer, oligomer, pre-polymer, or polymer, the polymer has a weight average molecular weight of 10000 to 100000, and the compound has a weight average molecular weight of 1000 to 100000.

19. The method as claimed in claim 18, wherein the polymer comprises polyvinyl alcohol or polyolefin, and the compound comprises polyethylene, polypropylene, polystyrene, polyvinyl chloride, monomer thereof, oligomer thereof, or pre-polymer thereof.

20. A composite material, comprising:
powder of a polymer uniformly distributed in a blend of the polymer and a compound, and the polymer and the compound have similar molecular structure;
wherein the compound has a first initially melting temperature and a first completely melting temperature,
wherein the polymer has a second initially melting temperature and a second completely melting temperature, and
wherein the first completely melting temperature is lower than the second initially melting temperature.

21. The composite material as claimed in claim 20, wherein the compound comprises monomer, oligomer, pre-polymer, or polymer.

22. The composite material as claimed in claim 20, wherein the polymer is polyester-type polymer, the compound is ester-type monomer, oligomer, pre-polymer, or polymer, the polymer has a weight average molecular weight of 10000 to 100000, and the compound has a weight average molecular weight of 1000 to 100000

23. The composite material as claimed in claim 22, wherein the polymer comprises thermoplastic polyester elastomer, polylactic acid, polyethylene terephthalate, polybutylene terephthalate, polyesteramide, or copolyester, and the compound comprises polyglycolic acid, polylactic acid, polycaprolactone, polyhydroxyalkanoate, polyhydroxybutyrate, polyethylene adipate, polybutylene succinate, polyethylene terephthalate, polybutylene terephthalate, polytrimethylene terephthalate, polyethylene naphthalate, monomer thereof, oligomer thereof, or pre-polymer thereof.

24. The composite material as claimed in claim 20, wherein the polymer is polyurethane-type polymer, the compound is polyurethane-type monomer, oligomer, pre-polymer, or polymer, the polymer has a weight average molecular weight of 10000 to 100000, and the compound has a weight average molecular weight of 1000 to 40000.

25. The composite material as claimed in claim 20, wherein the polymer is polyamide-type polymer, the compound is polyamide-type monomer, oligomer, pre-polymer, or polymer, the polymer has a weight average molecular weight of 10000 to 100000, and the compound has a weight average molecular weight of 1000 to 30000.

26. The composite material as claimed in claim 20, wherein the polymer is nylon12, nylon6, or TPAE, and the compound comprises nylon 6, nylon 66, nylon 6T, copolyamide, monomer thereof, oligomer thereof, or pre-polymer thereof.

27. The composite material as claimed in claim 20, wherein the polymer is polyacrylate-type polymer, the compound is polyacrylate-type monomer, oligomer, pre-polymer, or polymers the polymer has a weight average molecular weight of 10000 to 100000, and the compound has a weight average molecular weight of 1000 to 80000.

28. The composite material as claimed in claim 27, wherein the polymer comprises polymethyl methacrylate, polyacrylate, or polyacrylic acid, and the compound comprises polyacrylate, polyacrylic acid, monomer thereof, oligomer thereof, or pre-polymer thereof.

29. The composite material as claimed in claim 20, wherein the polymer is polyolefin-type polymer, the compound is polyolefin-type monomer, oligomer, pre-polymer, or polymer, the polymer has a weight average molecular weight of 10000 to 100000, and the compound has a weight average molecular weight of 1000 to 100000.

30. The composite material as claimed in claim 29, wherein the polymer comprises polyvinyl alcohol or polyolefin, and the compound comprises polyethylene, polypropylene, polystyrene, polyvinyl chloride, monomer thereof, oligomer thereof, or pre-polymer thereof.

31. The composite material as claimed in claim 20, wherein the compound contains a hydrophilic group, and the hydrophilic group include hydroxyl, carboxylic acid, amino, ammonium, phosphate, sulphate, sulfonic, sulfhydryl, or polyethylene oxide.

32. An ink for 3D printing an object of a polymer, comprising:
a compound,
wherein the polymer and the compound have similar molecular structure.

33. The ink as claimed in claim 32, wherein the compound comprises monomer, oligomer, pre-polymer, or polymer.

34. The ink as claimed in claim 32, wherein the compound contains a hydrophilic group to be dissolved in water to form an aqueous ink, and the hydrophilic group includes hydroxyl, carboxylic acid, amino, ammonium, phosphate, sulphate, sulfonic, sulfhydryl, or polyethylene oxide.

35. The ink as claimed in claim 32, wherein the ink further comprises wetting agent, solvent, or co-solvent.

36. The ink as claimed in claim 32, further comprising pigment, dye, surfactant, rheology modifier, defoamer, leveling agent, or a combination thereof.

37. The ink as claimed in claim 35, wherein the compound is dissolved or dispersed in the solvent to form the ink, and the solvent includes toluene, xylene, ethyl acetate, butyl acetate, methoxy propyl acetate, 2-ethoxyethanol, tetraethylene glycol dimethyl ether, propylene glycol methyl ether acetate, diethylene glycol diethyl ether, water, or a combination thereof.
